(19) United States
(12) Patent Application Publication
(10) Pub. No.: US 2025/0256648 A1
(43) Pub. Date: Aug. 14, 2025

(54) VEHICLE MIRROR DEVICE

(71) Applicant: KABUSHIKI KAISHA TOKAI-RIKA-DENKI-SEISAKUSHO, Aichi-ken (JP)

(72) Inventor: Yuto NAKAYAMA, Aichi (JP)

(21) Appl. No.: 19/041,304

(22) Filed: Jan. 30, 2025

(30) Foreign Application Priority Data
Feb. 13, 2024 (JP) 2024-019686

(51) Int. Cl. B60R 1/076

(52) U.S. Cl. CPC B60R 1/076

(57) ABSTRACT

A vehicle mirror device includes a visor rim and visor cover. The visor rim includes a housing tube that extends along a specific axial line direction, and that has a one-side in the axial line direction open with a mirror provided in an interior thereof, and includes a first engagement portion that is provided at an outer peripheral portion of the housing tube. The visor cover includes a first engaging portion that is capable of engaging with, or detaching from, the first engagement portion. The visor cover is supported by the visor rim in a mode positioned at an outer peripheral side of the housing tube when the first engaging portion has engaged with the first engagement portion.

### CROSS-REFERENCE TO RELATED APPLICATION

This application is based on and claims priority under 35 USC 119 from Japanese Patent Application No. 2024-019686, filed on Feb. 13, 2024, the disclosure of which is incorporated by reference herein.

### BACKGROUND

### Technical Field

The present disclosure relates to a vehicle mirror device.

### Related Art

Japanese Utility Model Registration No. 3194921 discloses a vehicle mirror device including a visor rim (body) that includes a housing tube to house a mirror and that is supported by a vehicle door through a support member, and a visor cover (cover member) that is installed so as to be capable of attaching to, or detaching from, the visor rim in a mode positioned at an outer peripheral side of the housing tube. The visor cover is connected to the visor rim by an engagement member of the visor rim engaging with an engagement member of the visor cover.

The engagement member of the visor rim is positioned at an inner peripheral side of the housing tube. This means that a large engagement member is not able to be provided to the visor rim in cases in which the diameter of the housing tube is small. Namely, a large engagement force has not been able to be achieved between the engagement member of the visor rim and the engagement member of the visor cover when the diameter of the housing tube is small.

In consideration of the above circumstances, an object of the present disclosure is to obtain a vehicle mirror device that is capable of providing a visor rim including a housing tube with a large first engagement portion for engaging with a first engaging portion of a visor cover, even when a diameter of a housing tube for housing a mirror is small.

### SUMMARY

A vehicle mirror device of a first aspect of the present disclosure includes a visor rim and a visor cover. The visor rim includes a housing tube that extends along a specific axial line direction, that has one side in an axial line direction open, and that has a mirror provided in an interior of the housing tube, and the visor rim including a first engagement portion that is provided at an outer peripheral portion of the housing tube. The visor cover includes a first engaging portion that is engageable with, or detachable from, the first engagement portion, the visor cover being supported by the visor rim in an aspect in which the visor cover is positioned at an outer peripheral side of the housing tube when the first engaging portion is engaged with the first engagement portion.

A vehicle mirror device of a second aspect of the present disclosure is the vehicle mirror device of the first aspect of the present disclosure, wherein the housing tube includes a resilient deformation section at which the first engagement portion is provided, and that is configured by a cantilever beam that is resiliently deformable to an inner peripheral side and an outer peripheral side of the housing tube.

A vehicle mirror device of a third aspect of the present disclosure is the vehicle mirror device of the second aspect of the present disclosure, wherein the housing tube is provided with a U-shaped cutout including a first portion adjacent to an end portion at the one side of the resilient deformation section, a second portion adjacent to an upper edge portion of the resilient deformation section and connected to the first portion, and a third portion adjacent to a lower edge portion of the resilient deformation section and connected to the first portion.

A vehicle mirror device of a fourth aspect of the present disclosure is the vehicle mirror device of any one of the first aspect to the third aspect of the present disclosure, wherein the visor rim is equipped with a second engagement portion positioned at an outer peripheral side of the housing tube, the visor cover. The visor cover includes a second engaging portion and the first engaging portion. The second engaging portion is engageable with, or detachable from, the second engagement portion, and restricts relative movement of the visor cover to the one side with respect to the visor rim by engaging with the second engagement portion. The first engaging portion, by engaging with the first engagement portion from the one side when the second engaging portion is engaged with the second engagement portion, restricts relative movement of the visor cover toward another side in the axial line direction with respect to the visor rim.

In the vehicle mirror device of the first aspect of the present disclosure, the visor rim includes the housing tube that extends along the specific axial line direction, and that has the one-side in the axial line direction open with the mirror provided in the interior thereof, and includes the first engagement portion provided to the outer peripheral portion of the housing tube. Furthermore, the visor cover that is supported by the visor rim in a mode positioned at the outer peripheral side of the housing tube includes the first engaging portion that is capable of engaging with, or detaching from, the first engagement portion. This means that the vehicle mirror device of the first aspect of the present disclosure is able to provide a large first engagement portion to the visor rim for engaging with the first engaging portion of the visor cover even in cases in which the diameter of the housing tube is small.

The housing tube of the vehicle mirror device of the second aspect of the present disclosure includes the resilient deformation section that is provided with the first engagement portion and that is configured by the cantilever beam capable of resiliently deforming to the inner peripheral side and the outer peripheral side of the housing tube. This means that in the vehicle mirror device of the second aspect, the first engagement portion and the first engaging portion are easily engaged.

In the vehicle mirror device of the third aspect of the present disclosure, for example, a tool inserted into a gap between the housing tube and the mirror is used to facilitate resilient deformation of the resilient deformation section such that engagement with the first engaging portion is released for the first engagement portion engaged with the first engaging portion.

The vehicle mirror device of the fourth aspect of the present disclosure enables relative movement of the visor cover to the one-side or the other-side in the axial line direction with respect to the visor rim to be restricted.

### BRIEF DESCRIPTION OF THE DRAWINGS

Exemplary embodiments of the present disclosure will be described in detail based on the following figures, wherein:

FIG. 1 is a perspective view of a door mirror device of an exemplary embodiment of the present disclosure, as viewed from the rear;

FIG. 2 is a perspective view of a door mirror device in a state in which a mirror and an upper cover have been separated, as viewed from the rear;

FIG. 3 illustrates a perspective view of a door mirror device in a state in which an upper cover has been separated, as viewed from the front;

FIG. 4 is an enlarged perspective view of a left side portion of a visor rim;

FIG. 5 is an enlarged perspective view of a left side portion of an upper cover;

FIG. 6 is a schematic perspective view of an inner face of a left side portion of a housing tube when a resilient deformation section is in a free state;

FIG. 7 is a cross-section of a visor rim left side portion and an upper cover left side portion illustrating a state in which a first engaging portion has contacted a resilient deformation section, as sectioned at the same position as arrow line 8-8 of FIG. 1; and

FIG. 8 is a cross-section taken along arrow line 8-8 of FIG. 1.

### DETAILED DESCRIPTION

Description follows regarding a vehicle mirror device 10 (hereafter referred to as door mirror device 10) of the present exemplary embodiment, with reference to the appended drawings. The door mirror device 10 of the present exemplary embodiment is provided to a side door (omitted in the drawings) on the left side of a vehicle. Note that as appropriately illustrated in the drawings, arrow FR indicates a front direction, arrow UP indicates upward, and arrow LH indicates a left direction.

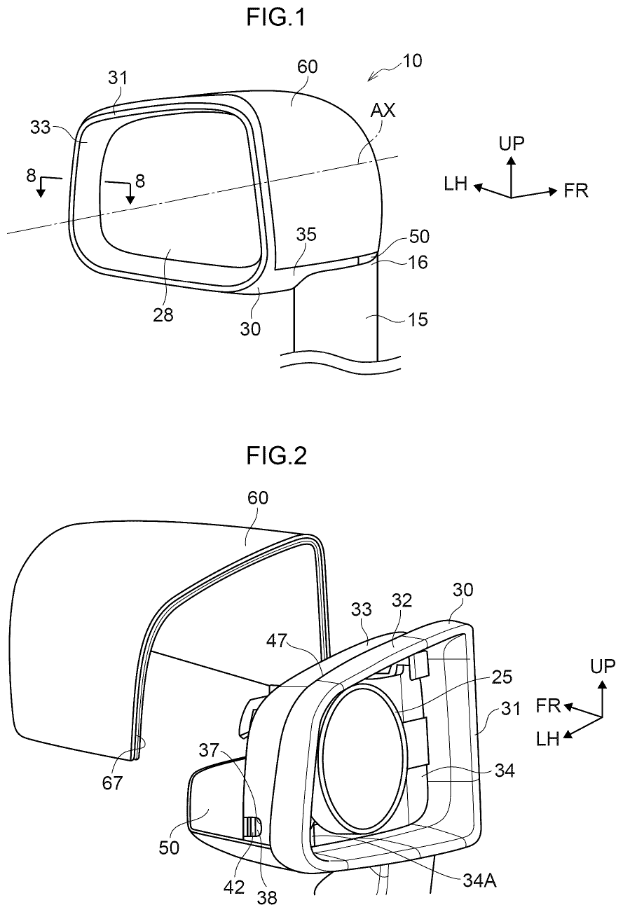

As illustrated in FIG. 1 to FIG. 3, the door mirror device 10 includes an arm member 15, a stowing mechanism 24, an actuator support member 25, a mirror 28, a visor rim 30, a lower cover 50, and an upper cover (visor cover) 60.

A one-end portion of the arm member 15 is supported by a side door. A support portion 16 is provide at an other-end portion of the arm member 15. Furthermore, the stowing mechanism 24 is provided on an upper face of the support portion 16, and the actuator support member 25 is provided to an upper portion of the stowing mechanism 24. Furthermore, the mirror 28 is supported by a mirror drive actuator (omitted in the drawings) provided to a rear portion of the actuator support member 25. An angle of the mirror 28 with respect to the actuator support member 25 is changed when the mirror drive actuator is operated.

The visor rim 30 that is an integrally molded component made from a resin includes, as illustrated in FIG. 2 to FIG. 4, a frame shaped portion 31, a flange portion 32, a housing tube 33, a bottom plate portion 34, and a lower supported portion 35. A face-on profile of the frame-shaped portion 31 that configures a rear end portion of the visor rim 30 is a substantially rectangular shape. The ring-shaped flange portion 32 projects forward from an outer peripheral edge portion of the frame-shaped portion 31. The ring-shaped housing tube 33 further projects forward from an inner peripheral edge portion of the frame-shaped portion 31. An amount by which the housing tube 33 projects forward is greater than that of the flange portion 32. The outer peripheral edge portion of the bottom plate portion 34 is connected to an inner peripheral edge portion of a front end portion of the housing tube 33. A through hole 34A is formed in a center portion of the bottom plate portion 34. Center axes (axial lines) AX of the frame-shaped portion 31 and the housing tube 33 (see FIG. 1 and FIG. 8) are substantially parallel to a front-rear direction. Furthermore, the lower supported portion 35 extends forward from a lower end portion of the frame-shaped portion 31.

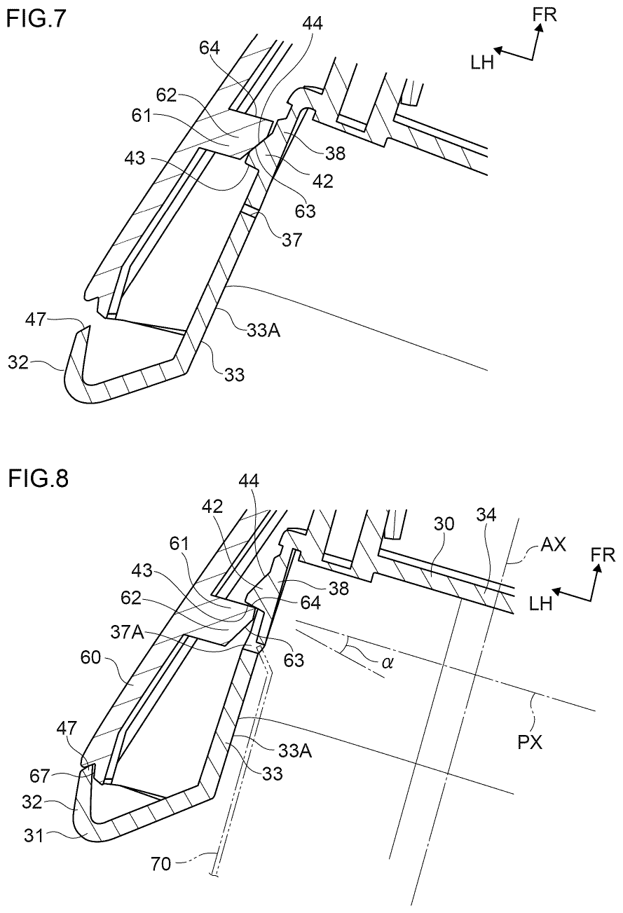

As illustrated in FIG. 2 to FIG. 4, a cutout 37 having a U-shaped profile in side view is formed in a left side portion of the housing tube 33. The cutout 37 includes a first portion 37A configuring a rear end portion thereof, a second portion 37B that extends forward from an upper end portion of the first portion 37A, and a third portion 37C that extends forward from a lower end portion of the first portion 37A. A resilient deformation section 38 is formed to a left side portion of the housing tube 33 so as to be accordingly surrounded by the cutout 37. Namely, a rear end portion of the resilient deformation section 38 is adjacent to the first portion 37A, an upper edge portion of the resilient deformation section 38 is adjacent to the second portion 37B, and a lower edge portion of the resilient deformation section 38 is adjacent to the third portion 37C. The resilient deformation section 38 is a cantilever beam with a front end portion thereof serving as a supported end. Namely, the resilient deformation section 38 is capable of deforming resiliently in a thickness direction (to an inner peripheral side and an outer peripheral side) of the left side portion of the housing tube 33. When the resilient deformation section 38 is in a free state as illustrated in FIG. 6 and FIG. 7, a design face 33A that is an inner peripheral face of the housing tube 33, and an inner face of the resilient deformation section 38, are in the same plane as each other.

Furthermore, as illustrated in FIG. 4 and FIG. 8, a first engagement portion 42 is provided to an outer face (left side face) of the resilient deformation section 38. A profile of the first engagement portion 42 is substantially a triangular column that is substantially parallel to the height direction. A rear face of the first engagement portion 42 is configured by an engagement face 43 formed from a flat face, and an outer face (left side face) of the first engagement portion 42 is configured from a guide face 44 formed from a flat face inclined with respect to the engagement face 43 in plan view.

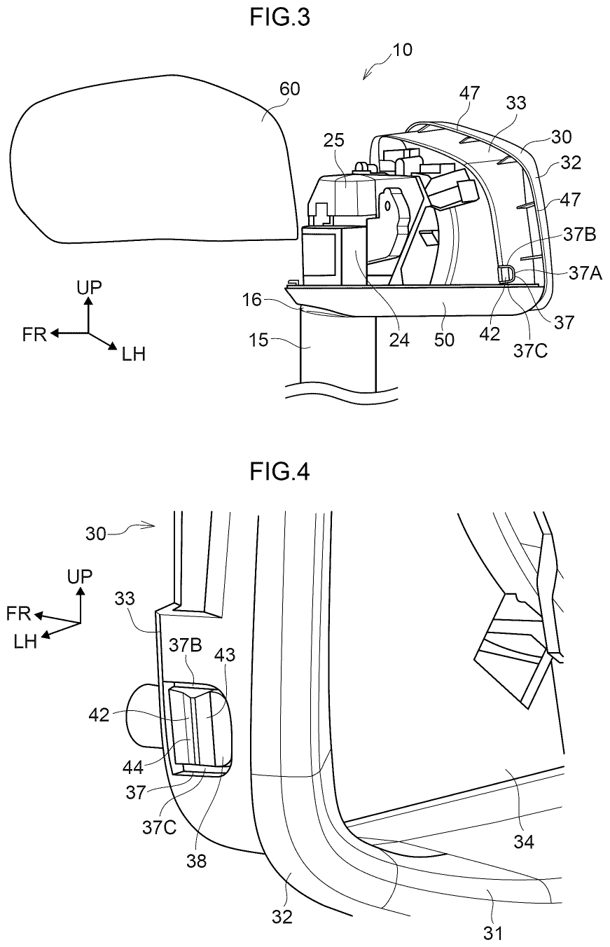

Furthermore, as illustrated in FIG. 2, FIG. 3, FIG. 7, and FIG. 8, a second engagement portion 47 is provided to an entire front edge portion of the flange portion 32 excluding a lower end portion thereof.

Part of the visor rim 30 having such a configuration is fixed to the actuator support member 25, and a rear portion of the actuator support member 25 passes rearward through a through hole 34A. When the visor rim 30 is fixed to the actuator support member 25, the mirror 28 is positioned at the interior of the housing tube 33, as illustrated in FIG. 1.

The lower cover 50, which is an integrally molded component made from a resin, is screwed to the visor rim 30 at plural individual locations.

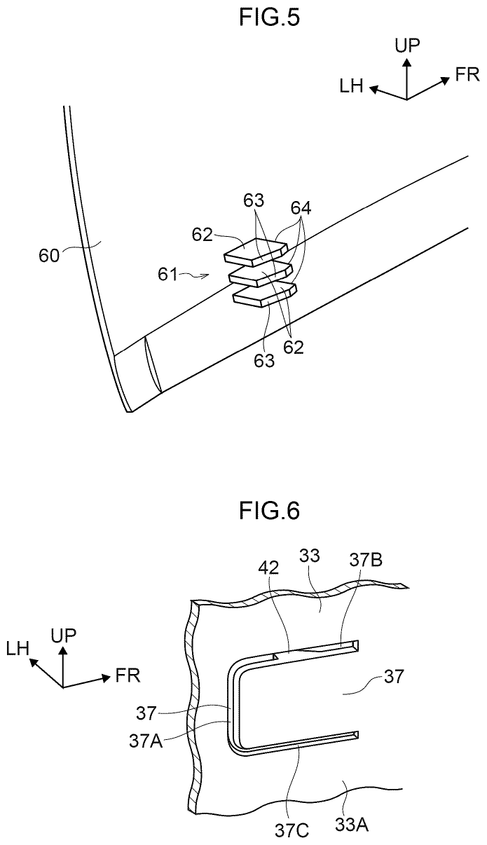

The upper cover 60, which is an integrally molded component made from a resin, is a hollow body opening at a rear face and a lower face. As illustrated in FIG. 5, a first engaging portion 61 is provided to an inner face at a left side portion of the upper cover 60. The first engaging portion 61 includes three engagement projections 62 separated from each other in the height direction. A guided face 63 is formed to a right side edge portion of each of the engagement projections 62 so as to be inclined with respect to the left-right direction and the front-rear direction in plan view, and an engaging face 64 is formed to a front edge portion of each of the engagement projections 62 so as to be substantially perpendicular to the front-rear direction in plan view.

Furthermore, as illustrated in FIG. 7 and FIG. 8, a second engaging portion 67 configured as a groove is formed around the entire periphery of a rear edge portion of the upper cover 60.

When the upper cover 60 that is separated to the front from the visor rim 30, as illustrated in FIG. 2 and FIG. 3, is moved rearward, the guided face 63 of each of the engagement projections 62 of the first engaging portion 61 contacts the guide face 44 of the first engagement portion 42 provided to the resilient deformation section 38, which is in a free state, of the visor rim 30, as illustrated in FIG. 7. When the upper cover 60 is moved further rearward from this state, each of the engagement projections 62 overrides the guide face 44 toward the rear by the resilient deformation section 38 deforming resiliently toward the inner peripheral side (right side) of the visor rim 30 about the support end (front end portion). The resilient deformation section 38 attempts to return to the free state when each of the engagement projections 62 has been moved to the rear of the guide face 44. As a result thereof, the engagement face 43 of the first engagement portion 42 of the resilient deformation section 38 that is in a slightly resiliently deformed state from the free state, and the engaging face 64 of each of the engagement projections 62, engage with each other, as illustrated in FIG. 8. Furthermore, the entire second engaging portion 67 of the upper cover 60 engages with the second engagement portion 47 of the flange portion 32 of the visor rim 30. The upper cover 60 is, as illustrated in FIG. 1, accordingly installed attachable to, or detachable from, the visor rim 30 and to the lower cover 50 so as to cover the stowing mechanism 24 and the actuator support member 25. Furthermore, the visor rim 30 and the upper cover 60 are then screwed together at plural individual locations. This thereby completes the door mirror device 10 illustrated in FIG. 1.

Next, description follows of the operation and advantageous effects of the present exemplary embodiment.

The visor rim 30 of the door mirror device 10 includes the housing tube 33 that extends along the center axis AX, and that has a center axis AX direction one-side (rear side) that is open and that has the mirror 28 provided in the interior thereof, and the first engagement portion 42 is provided to an outer peripheral portion of the housing tube 33. Furthermore, the upper cover 60 supported by the visor rim 30 in a mode positioned at the outer peripheral side of the housing tube 33 includes the first engaging portion 61 that is engageable with the first engagement portion 42. The first engagement portion 42 is provided to the outer peripheral portion of the housing tube 33 in this manner, and so this enables a large first engagement portion 42 for engaging with the first engaging portion 61 to be provided to the visor rim 30 even in cases in which a diameter of the housing tube 33 having the center axis AX at the center thereof is small. Accordingly, the door mirror device 10 is able to achieve a larger engagement force between the first engagement portion 42 and the first engaging portion 61 even in cases in which the diameter of the housing tube 33 is small.

Furthermore, the first engaging portion 61 is equipped with the three individual engagement projections 62 and so a larger engagement force can be achieved between the first engagement portion 42 and the first engaging portion 61 than cases in which the first engaging portion 61 is configured by a single individual engagement projection 62.

The housing tube 33 of the visor rim 30 of the door mirror device 10 includes the resilient deformation section 38 that is provided with the first engagement portion 42 and that is configured as a cantilever beam capable of resiliently deforming to the inner peripheral side and the outer peripheral side of the housing tube 33. This thereby enables the first engaging portion 61 to be engaged with the first engagement portion 42 easily when the upper cover 60 is installed to the visor rim 30.

Furthermore, the visor rim 30 of the door mirror device 10 is equipped with the second engagement portion 47, and the upper cover 60 is equipped with the second engaging portion 67. The second engagement portion 47 and the second engaging portion 67 engage with each other further rearward than the first engagement portion 42 and the first engaging portion 61. This means that relative movement of the upper cover 60 toward the center axis AX direction one-side (rear) and other-side (front) with respect to the visor rim 30 is restricted by the first engagement portion 42, the second engagement portion 47, the first engaging portion 61, and the second engaging portion 67.

Furthermore, when a direction perpendicular to the center axis AX in plan view is defined as being a perpendicular direction PX as illustrated in FIG. 8, the engagement face 43 of the first engagement portion 42 engaged with the engagement projection 62 is inclined at an angle a to the rear with respect to the perpendicular direction PX. This means that when a forward external force is imparted to the upper cover 60 in this state, each of the engagement projections 62 is guided to the right side by the engagement face 43. Namely, the first engaging portion 61 is moved, by the engagement face 43, in a direction to increase the amount of engagement between the engaging face 64 and the engagement face 43. This means that there is little concern of disengagement of the engaged state between the first engagement portion 42 and the first engaging portion 61 even if a forward force were to be unintendedly imparted to the upper cover 60.

Furthermore, the first portion 37A is provided to a rear end portion of the cutout 37. This means that the engagement between the first engagement portion 42 and the first engaging portion 61 can be intentionally released by inserting a tool 70 (see FIG. 8) into a gap between a left side section of the frame-shaped portion 31 and the housing tube 33, and left side section of the mirror 28, and by using a leading end portion of the tool 70 to move a rear end portion of the resilient deformation section 38 toward the inside (right side) of the housing tube 33. Namely, after the plural screws mentioned above have been removed from the visor rim 30 and the upper cover 60, the upper cover 60 can be intentionally removed from the visor rim 30 easily by using the tool 70.

Furthermore, as illustrated in FIG. 6 and FIG. 7, when the resilient deformation section 38 is in a free state, the design face 33A that is the inner peripheral face of the housing tube 33, and the inner face of the resilient deformation section 38, are in the same plane as each other. This means that styling of the door mirror device 10 is not liable to be spoilt by the resilient deformation section 38 even in cases in which the design face 33A is exposed through a gap between the left side portions of the frame-shaped portion 31 and the housing tube 33, and the left side portion of the mirror 28.

Although explanation has been given above regarding the door mirror device 10 according to an exemplary embodiment, appropriate design changes to the door mirror device 10 are possible within a range not departing from the spirit of the present disclosure.

The first engaging portion 61 may be equipped with a single individual engagement projection 62 alone. The first engaging portion 61 may also be equipped with two or four or more of the engagement projections 62.

The shape of each of the engagement projections 62 may be different to the shape in the above exemplary embodiment.

The present disclosure is also applicable to a door mirror device on the right side.

What is claimed is:

1. A vehicle mirror device, comprising:
a visor rim including a housing tube that extends along a specific axial line direction, that has one side in an axial line direction open, and that has a mirror provided in an interior of the housing tube, and the visor rim including a first engagement portion that is provided at an outer peripheral portion of the housing tube; and
a visor cover including a first engaging portion that is engageable with, or detachable from, the first engagement portion, the visor cover being supported by the visor rim in an aspect in which the visor cover is positioned at an outer peripheral side of the housing tube when the first engaging portion is engaged with the first engagement portion.

2. The vehicle mirror device of claim 1, wherein the housing tube includes a resilient deformation section at which the first engagement portion is provided, and that is configured by a cantilever beam that is resiliently deformable to an inner peripheral side and an outer peripheral side of the housing tube.

3. The vehicle mirror device of claim 2, wherein the housing tube is provided with a U-shaped cutout including a first portion adjacent to an end portion at the one side of the resilient deformation section, a second portion adjacent to an upper edge portion of the resilient deformation section and connected to the first portion, and a third portion adjacent to a lower edge portion of the resilient deformation section and connected to the first portion.

4. The vehicle mirror device of claim 1, wherein:
the visor rim is equipped with a second engagement portion positioned at an outer peripheral side of the housing tube, and
the visor cover includes:
a second engaging portion that is engageable with, or detachable from, the second engagement portion, and that restricts relative movement of the visor cover to the one side with respect to the visor rim by engaging with the second engagement portion; and
the first engaging portion that, by engaging with the first engagement portion from the one side when the second engaging portion is engaged with the second engagement portion, restricts relative movement of the visor cover toward another side in the axial line direction with respect to the visor rim.
